(19) United States
(12) Patent Application Publication
(10) Pub. No.: US 2022/0025999 A1
(43) Pub. Date: Jan. 27, 2022

(54) Hose Structure with Reinforced Pressure Sleeve

(71) Applicant: Swan Products, LLC, Sandy Springs, GA (US)

(72) Inventors: Tim O'Connor, Eden, NY (US); Erick Williams, Roswell, GA (US); Jose Rossi, Mississauga (CA)

(21) Appl. No.: 16/935,287

(22) Filed: Jul. 22, 2020

(51) Int. Cl. F16L 33/207; F16L 57/00; F16L 47/06; F16L 47/22

(52) U.S. Cl. CPC F16L 33/2076; F16L 47/22; F16L 47/06; F16L 57/005

(57) ABSTRACT

Disclosed is a reinforced hose comprising a pressure sleeve concentrically installed over an outer surface of the hose tubing, either above or below the ferrule. An inner diameter of the pressure sleeve is larger than an outer diameter of the hose tubing and the first terminal end of the pressure sleeve is longitudinally aligned with the first open end of the hose tubing. The longitudinal length of the pressure sleeve is greater than that of the ferrule and extends beyond a proximal end of the ferrule. A first interference joint couples the outer surface of the hose tubing to an inner surface of the pressure sleeve, the first interference joint comprising a contact patch located between the second terminal end of the pressure sleeve and the proximal end of the ferrule.

### TECHNICAL FIELD

The present technology pertains to tubings and hoses, and more specifically to the reinforcement of garden and other fluid carrying hoses for improved burst characteristics and pressure cycling performance thereof.

### BACKGROUND

Flexible hoses are commonly used to convey fluids over a wide range of temperatures and pressurizations, both of which may change in accordance with use case and/or environmental conditions. For example, a garden hose might be used to convey water from a relatively high-pressure source such as a municipal water supply or from a relatively low-pressure source such as a cistern; the same garden hose might also be used to convey cold water during early spring and hot water during late summer.

On top of these varying fluid characteristics that garden hoses must be able to handle, hoses are commonly subjected to moderately rapid pressure cycling, i.e., in which the hose is used for many short periods rather than for a prolonged period of time. Such pressure cycling can noticeably increase the wear and tear experienced by hoses and other tubings, or otherwise noticeably reduce their durability, as each pressurization cycle produces a shear force and expansion of the hose wall. Repeated pressure cycling typically leads to a bursting type failure in which the hose wall splits at or near the area which has experienced the greatest amount of shearing force. In conventional garden hoses, this failure point is typically located directly behind the ferrule attached to the open end of the hose.

In conventional hoses, reinforcement is achieved by strengthening the entirety of the hose, along its full end-to-end length. For example, many hoses are manufactured by extruding layers of PVC or other material and wrapping reinforcement yarns between the layers in order to provide greater strength and durability. However, the use of reinforcement yarns can increase manufacturing costs and lead to a hose that is undesirably stiff or rigid, as these yarns obtain better burst performance by sacrificing pliability. Some hoses are manufactured with a greater wall thickness but are similarly hampered by increased manufacturing costs while also being much heavier and more difficult to use.

Accordingly, it would be desirable to provide a lightweight, easy to manipulate, burst-resistant hose without making adaptations along the full end-to-end length of the hose.

### SUMMARY OF THE INVENTION

In an aspect of the invention, there is provided a reinforced hose comprising: a hollow hose tubing having first and second open ends; a ferrule installed on the hose tubing about the first open end; a pressure sleeve concentrically installed over an outer surface of the hose tubing, the pressure sleeve having first and second terminal ends with a hollow cylindrical tube formed therebetween, wherein: an inner diameter of the pressure sleeve is larger than an outer diameter of the hose tubing; the first terminal end of the pressure sleeve is longitudinally aligned with the first open end of the hose tubing; and the second terminal end of the pressure sleeve extends longitudinally beyond a proximal end of the ferrule such that the longitudinal length of the pressure sleeve is greater than that of the ferrule, the proximal end of the ferrule being the portion thereof farthest from the first open end of the hose tubing; and a first interference joint coupling the outer surface of the hose tubing to an inner surface of the pressure sleeve, the first interference joint comprising a contact patch located between the second terminal end of the pressure sleeve and the proximal end of the ferrule.

In a further aspect, the inner surface of the pressure sleeve is in contact with the outer surface of the hose tubing along the full longitudinal length of the pressure sleeve; and a portion of the pressure sleeve, located between the proximal end of the ferrule and the first open end of the hose tubing, is compressed between the outer surface of the hose tubing and an inner surface of the ferrule.

In a further aspect, the ferrule is crimped in place on top of concentric layers formed by the pressure sleeve and the hose tubing, such that the portion of the pressure sleeve is compressed.

In a further aspect, the reinforced hose further comprises a second interference joint coupling the outer surface of the hose tubing to the inner surface of the pressure sleeve, the second interference joint located between the proximal end of the ferrule and the first open end of the hose tubing.

In a further aspect, one or more of the first interference joint and the second interference joint comprises a contact patch formed by heat shrinking the pressure sleeve onto the outer surface of the hose tubing.

In a further aspect, the first and second interference joint comprise a single contact patch formed by a single heat shrinking operation.

In a further aspect, the ferrule is crimped in place about the first open end of the hose tubing; and the ferrule is encapsulated along its full longitudinal length by the pressure sleeve.

In a further aspect, the outer surface of the hose tubing is in direct contact with an inner surface of the ferrule.

In a further aspect, the pressure sleeve is installed on top of the crimped ferrule such that the outer surface of the ferrule is in contact with the inner surface of the pressure sleeve along a second contact patch.

In a further aspect, the second contact patch between the outer surface of the ferrule and the inner surface of the pressure sleeve: has a longitudinal length substantially equal to that of the ferrule; and is located between the proximal end of the ferrule and the first open end of the hose tubing.

In a further aspect, the second contact patch comprises a second interference joint.

In a further aspect, the second interference joint comprises a heat shrink joint that radially compresses the ferrule and hose tubing along the second contact patch.

In a further aspect, the first interference joint comprises a heat shrink joint along the first contact patch.

In a further aspect, the first and second interference joints are formed in a single, continuous heat shrink operation.

In a further aspect, the reinforced hose further comprises: a second ferrule installed about the hose tubing at the second open end; a second pressure sleeve concentrically installed over an outer surface of the hose tubing, the second pressure sleeve having first and second terminal ends with a hollow cylindrical tube formed therebetween, wherein: an inner diameter of the second pressure sleeve is larger than an outer diameter of the hose tubing; the first terminal end of the second pressure sleeve is longitudinally aligned with the second open end of the hose tubing; and the second terminal end of the second pressure sleeve extends longitudinally beyond a proximal end of the second ferrule, such that the longitudinal length of the second pressure sleeve is greater than that of the second ferrule, the proximal end of the second ferrule being the portion thereof farthest from the second open end of the hose tubing; and a third interference joint coupling the outer surface of the hose tubing to an inner surface of the second pressure sleeve, the third interference joint comprising a contact patch located between the second terminal end of the second pressure sleeve and the proximal end of the second ferrule.

In a further aspect, the concentric arrangement of layers comprising the hose tubing at the second open end, the second ferrule, and the second pressure sleeve is installed in the same order as the concentric arrangement of layers comprising the hose tubing at the first open end, the first ferrule, and the first pressure sleeve.

In a further aspect, the concentric arrangement of layers comprising the hose tubing at the second open end, the second ferrule, and the second pressure sleeve is installed in a different order as compared to the concentric arrangement of layers comprising the hose tubing at the first open end, the first ferrule, and the first pressure sleeve.

In a further aspect, the hollow cylindrical tube formed between the first and second terminal ends of the pressure sleeve comprises a continuous smooth surface having a constant inner diameter.

In a further aspect, the pressure sleeve has a constant inner diameter prior to installation over the crimped ferrule.

In a further aspect, the hose tubing comprises one or more of polyvinyl chloride (PVC), thermoplastic elastomer (TPE), thermoplastic polyurethane (TPU), nylon, polyethylene, and synthetic and natural rubber.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 depicts an example view of burst failures in garden hoses;

FIG. 2 depicts two reinforced hoses of the present disclosure, one having a pressure sleeve over the ferrule and one having a pressure sleeve under the ferrule, in a side-by-side view with a non-reinforced garden hose;

FIGS. 3A-C depict exploded views of an example assembly of a reinforced hose having a pressure sleeve installed under the ferrule; and

FIGS. 4A-C depict exploded views of an example assembly of a reinforced hose having a pressure sleeve installed over the ferrule.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Additional features and advantages of the disclosure will be set forth in the description which follows, and in part will be obvious from the description, or can be learned by practice of the herein disclosed principles.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale, and the proportions of certain parts may be exaggerated to better illustrate details and features. The description is not to be considered as limiting the scope of the embodiments described herein.

Hoses are often used in a manner in which they are repeatedly pressurized (i.e., used to convey a pressurized fluid such as water from a spigot) for short bursts of time. For example, in a common scenario a garden hose might be turned on and off 5-10 times per day by a homeowner watering plants that are spread about various different locations. Pressure cycling alone can ultimately cause failures in hoses due to the shear forces and expansion experienced in the hose wall during each cycle. Exacerbating this effect is the fact that garden hoses are used over wide ranges of fluid pressure and temperature.

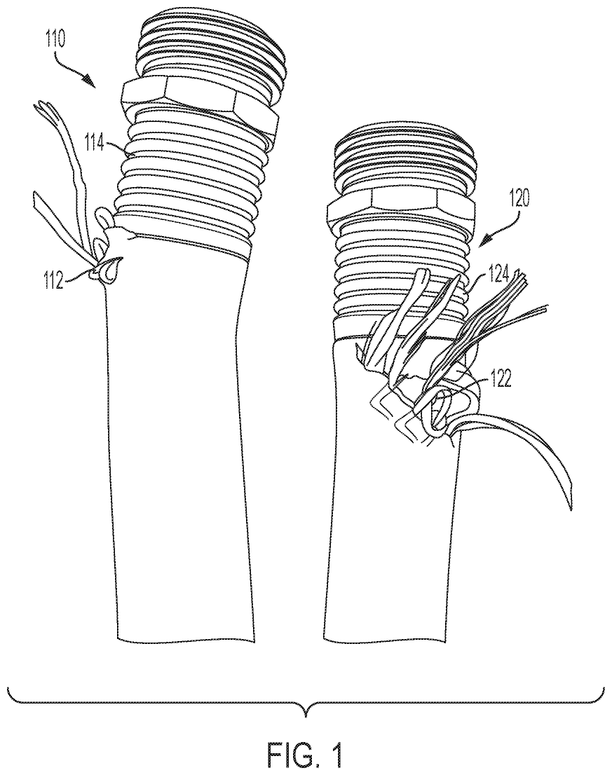

The most common failure mode for many garden hoses is bursting, typically at the portion of the hose wall where the shearing forces are at a maximum during pressurization. In particular, garden hoses are prone to bursting at the ferrule or other coupling attachment point, where the end hardware of the hose is crimped into or otherwise attached to the hose wall. For example, FIG. 1 depicts burst mode failures in two example garden hoses 110, 120—notably, each hose exhibits a bursting failure (112, 122) at a point that is below the ferrule (114, 124). For the purposes of this example, neither hose is reinforced with the pressure sleeve as disclosed herein, and the two hoses 110, 120 are otherwise of a conventional garden hose construction. This observation of bursting behind the ferrule is especially prominent with certain types of garden hoses manufactured from rubber or TPR (thermoplastic rubber), although it remains broadly applicable to garden hoses as a whole. Indeed, bursting in garden hoses is a major driver of user dissatisfaction and as such it would be desirable to provide burst-resistant reinforcement at the coupling ends of a garden hoses without having to compromise other desirable characteristics such as weight, ease of handling, and/or pliability.

For example, when subjected to an impulse test in which water at a fixed temperature is cycled between an upper and lower pressure threshold (e.g., from 0-100 PSI (pounds per square inch)), hoses such as the two hoses 110, 120 were observed experiencing burst failures directly behind the ferrule after only a few hundred pressurization cycles of the pressure impulse test with a water temperature of 120° F. By contrast, reinforced garden hoses according to aspects of the present disclosure were observed withstanding over 1,000 pressurization cycles of the same pressure impulse test (at the same 120° F. water temperature) without failure, before the impulse test was ended—still without the reinforced hoses experiencing a bursting or other failure.

In another example, a PLC was used to control and run a pressure impulse test for 120 hours or 43,000 pressurization cycles. Cold water, at a temperature of 70° F. was cycled between 0-100 PSI at six pressure cycles per minute. Conventional, un-reinforced hoses such as the two hoses 110, 120 seen in FIG. 1 were observed experiencing bursting failures or otherwise blowing out after approximately 38,000 pressure cycles. By contrast, reinforced garden hoses according to aspects of the present disclosure were observed withstanding all 120 hours and 43,000 pressurization cycles of the same pressure impulse test before the test was ended at the scheduled time, without any of the presently disclosed reinforced, pressure-sleeved garden hoses experiencing a failure.

Disclosed is hose having a reinforced pressure sleeve (also referred to herein as a “burst sleeve”) provided at one or more of its open ends, such that the reinforced hose exhibits greater durability and handling characteristics and moreover is resistant to bursting and kinking. In some embodiments, the presently disclosed hose having a reinforced pressure sleeve provides at least a 10-15% improvement in life cycle durability when compared to conventional, non-pressure sleeve-reinforced hoses. Additionally, in some embodiments a greater than 15% improvement in life cycle durability can be achieved when stronger and/or thicker materials are chosen for the pressure sleeve, as will be discussed in greater detail below. In some embodiments, the reinforced pressure sleeve can be installed underneath the ferrule at a hose end and/or can be installed on top of the ferrule at the hose end. It is appreciated that although a ferrule is referenced in the following discussion and is depicted in the instant figures, that this is for purposes of example and is not to be construed as limiting—other end coupling hardware and assemblies for garden hoses can be reinforced with pressure sleeves in either the over or under configuration, all without departing from the scope of the present disclosure.

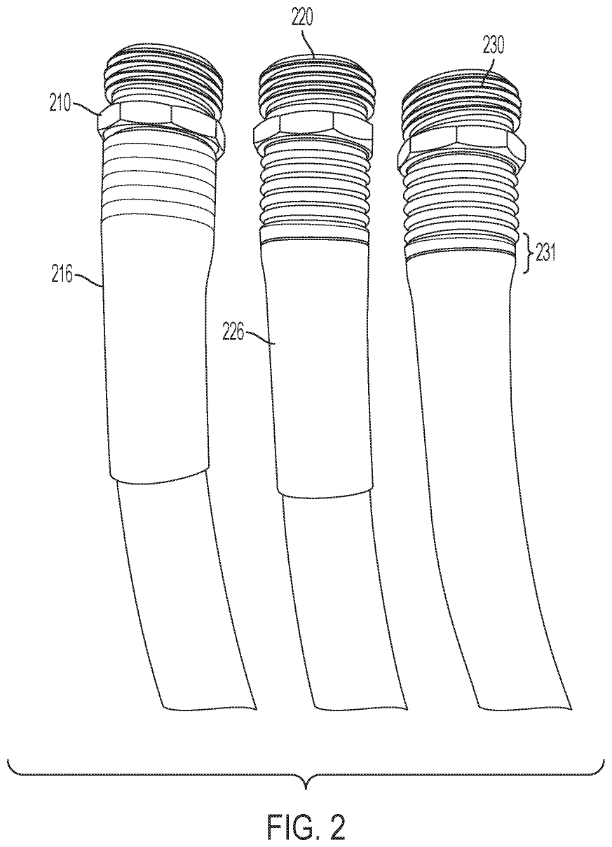

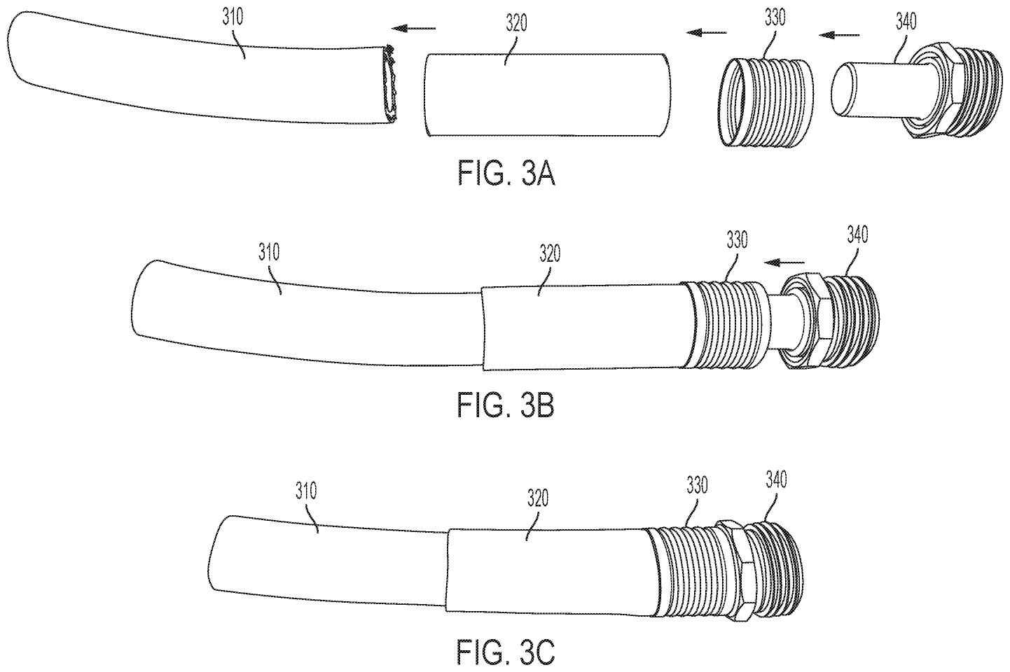

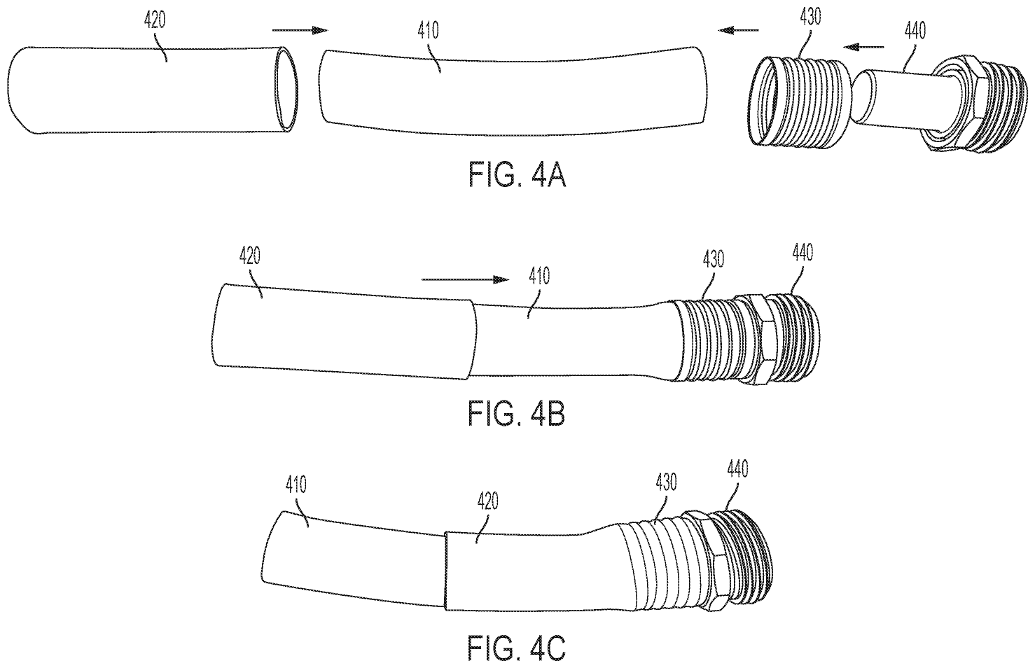

FIG. 2 depicts a side-by-side view of two reinforced hoses 210, 220 in which pressure sleeves 216, 226 are installed according to aspects of the present disclosure. Also shown is a non-reinforced hose 230 in which no pressure sleeve is installed. The constituent components and their manner of integration are discussed in greater depth with respect to FIGS. 3A-4C; FIG. 2 is provided as an overview of the differences between the final assembled state of the two example reinforced hoses 210, 220 and non-reinforced hose 230.

Reinforced hose 210 is an example of the pressure sleeve over ferrule configuration, in which pressure sleeve 216 is installed such that it encapsulates the ferrule at the open end of the hose (i.e., the end hardware of the hose typically having male or female threading allowing the hose to be connected to spigots, nozzles, etc.). Pressure sleeve 216 may encapsulate the ferrule fully, as is illustrated, or may encapsulate the ferrule only partially. In addition to the ferrule, pressure sleeve 216 also encapsulates a portion of the outer surface of the hose tubing that is immediately below the proximal end of the ferrule (i.e., the far end of the ferrule, away from the open end of the hose through which fluid enters/exits). In some embodiments, it is contemplated that pressure sleeve 216 is affixed or otherwise coupled to hose 210 without the use of adhesives and/or mechanical fasteners. For example, the pressure sleeve can comprise a heat shrink material such as polyolefin, such that the pressure sleeve is installed onto the reinforced hose and then coupled or otherwise affixed via the application of heat, although it is appreciated that various other heat shrink materials can be utilized without departing from the scope of the present disclosure.

In some embodiments, pressure sleeve 216 can be installed onto hose 210 during manufacture, i.e., after the manufacture of the hose tubing itself but prior to the attachment of a ferrule or end coupling to the open end of the hose. For example, pressure sleeve 216 can be slid down the length of the hose tubing (toward the opposite open end) to allow a ferrule to be crimped onto the closer open end. With the ferrule in place, pressure sleeve 216 can then be moved back towards the closer open end and longitudinally aligned with the crimped ferrule. With suitable alignment achieved, a heat shrink operation can be applied to shrink pressure sleeve 216 to encapsulate the crimped ferrule and reinforce the transition zone between the wall of the hose tubing and the bottom end of the ferrule. In some embodiments, a complete end coupling assembly (e.g., threaded for male or female attachment to spigots, nozzles, etc.) can be fit in place to the ferrule prior to heat shrinking pressure sleeve 216 in place. As will be discussed in greater depth below with respect to FIGS. 4A-C, the inner diameter (ID) of pressure sleeve 216 prior to heat shrinking can be sized to be larger than the outer diameter (OD) of hose 210's outer tubing wall, to allow for the easy installation and manipulation of the non-shrunken pressure sleeve 216 with respect to hose 210 and/or any ferrules and coupling hardware installed onto hose 210.

Returning to the discussion of reinforced hose 210 having a pressure sleeve over ferrule configuration, regardless of the longitudinal extent to which pressure sleeve 216 reaches toward the terminal end of reinforced hose 210, pressure sleeve 216 is sized and installed such that it will cover the transition zone between the outer tubing of the hose and the lower lip/circumference of the ferrule installed on the hose. For reference, this transition zone is indicated at 231 on the non-reinforced hose 230—recall from FIG. 1 and its accompanying discussion that non-reinforced hoses most commonly experience bursting failures in or along this transition zone 231 where the ferrule attaches to the hose.

Having briefly discussed the pressure sleeve over ferrule configuration of reinforced hose 210, the disclosure turns now to the pressure sleeve under ferrule configuration—an example of which is illustrated by reinforced hose 220. In particular, a pressure sleeve 226 is installed such that the pressure sleeve's full length makes contact with the outer surface of hose 220 but—unlike in the pressure sleeve over ferrule configuration—does not encapsulate or otherwise make contact with the outer surface of the ferrule at the open end of hose 220. Instead, the ferrule encapsulates the upper portion of pressure sleeve 226, in the pressure sleeve under ferrule configuration of reinforced hose 220.

In some embodiments, pressure sleeve 226 can be fitted on the tubing of hose 220 in a first step, and a ferrule or other end connector hardware can be subsequently installed on top of both the pressure sleeve and the hose tubing in a second step (e.g. by crimping the ferrule to radially compress the hose wall and pressure sleeve between the inner and outermost ferrule portions). In instances where pressure sleeve 226 comprises a heat shrink material, a heat shrinking operation can be applied as an intermediate step before crimping on the ferrule. For example, after pressure sleeve 226 has been situated about the outer surface of the hose tubing near its open end, the pressure sleeve can be shrunk onto the hose tubing via a hot water bath/dip or other application method causing sufficient heat transfer into pressure sleeve 226 to trigger shrinking. In some embodiments, the heat shrinking operation can be applied or performed after the ferrule has been crimped in place on top of pressure sleeve 226 (although such a scenario might require that the pressure sleeve OD, in a non-shrunken state, closely match the ID of the ferrule—otherwise, as pressure sleeve 226 contracts from the heat shrinking operation, its outer surface will pull away from the crimped attachment with the ferrule).

Other heat shrinking methods such as the use of a heat gun or radiant heat may also be employed, although these methods risk overheating the actual hose material itself and causing undesirable warping, weakening or other damage. Depending on the size differential, and in particular the diameter differential, between the hose tubing, the pressure sleeve and the ferrule, in some embodiments the ferrule can be crimped onto a first end of pressure sleeve 226 and the tubing of hose 220 subsequently or simultaneously inserted into the second end of the pressure sleeve.

As illustrated, the pressure sleeve extends beyond the proximal end of the ferrule (i.e., towards the midpoint of the hose's length) in both reinforced hose 210 and reinforced hose 220. By extending beyond the ferrule, pressure sleeves 216, 226 can provide the additional benefit of strain relief, and in some embodiments the total length of the pressure sleeve can be increased or decreased in order to impart a greater or lesser degree of strain relief functionality to the reinforced hose. Additionally, a more rigid pressure sleeve, whether by way of increased wall thickness or material choice, can in some embodiments also be utilized to provide additional strain relief to the reinforced hoses 210, 220. In some embodiments, both reinforced hoses 210, 220 can be configured with pressure sleeves that are substantially similar or identical.

Advantageously, the use of the presently disclosed pressure sleeves, whether in the over or under ferrule configuration, specifically targets and reinforces the area in which conventional or non-reinforced hoses are most prone to suffering burst failures, i.e., the transition zone 231 between hose wall and ferrule. Unlike other reinforcement techniques such as adding additional hose/tubing layers, additional reinforcement yarns, using thicker hose/tubing walls or reinforcement yarns, the disclosed pressure sleeves do not require integration along the full length of the hose. The aforementioned reinforcement techniques are achieved by making modifications to the input components to the continuous process in which the hose or tubing is manufactured—such reinforcements therefore must be applied to the entire length of the hose, even when it is only the transition zones 231 near the ferrules that are in need of reinforcement against bursting. Extraneous reinforcement running the whole length of the hose increases weight and can negatively impact handling characteristics, making the hose more difficult to lift or, in the case of a more rigid hose, more difficult to maneuver and manipulate. Moreover, full-length hose reinforcement techniques come at an increased cost to both the manufacturer and the consumer.

By applying selective reinforcement to just the most sensitive, burst-prone zones, the reinforced hoses 210, 220 of the present disclosure eliminate the inefficiencies and inconveniences associated with full-length hose reinforcement as discussed above. Moreover, when pressure sleeves are installed at one or both ferrules/open ends of a hose, the hose tubing itself can be built thinner while still maintaining or exceeding the performance achieved by the (non-pressure sleeve reinforced) tubing at its original thickness. A thinner hose/tubing wall not only reduces manufacturing costs but can also reduce shipping costs due to its corresponding lower weight. To end users, a thinner hose wall results in better handling characteristics, i.e., because the thinner hose can be both lighter and more flexible, while the use of pressure sleeves to reinforce the thinner hose tubing provides burst protection and greater durability specifically targeted to the region of hose wall near the ferrules that is the source of most failures and user complaints. Further still, the strain relief functionality imparted by the pressure sleeves can be useful with thinner hose walls, which might otherwise be more prone to kinking in the absence of the pressure sleeves/strain relief.

The disclosure turns now to FIGS. 3A-C, the views of which depict, in various degrees of assembly, an example reinforced hose having a pressure sleeve installed under the ferrule (corresponding views of a reinforced hose having a pressure sleeve installed over the ferrule are depicted in FIGS. 4A-C). It is noted that the series or progression illustrated in FIGS. 3A-C is provided for clarity of explanation and as an example, and is not meant to be construed as limiting with respect to the order of manufacturing operations or assembly steps contemplated with respect to reinforced hoses having a pressure sleeve under the ferrule configuration. The following discussion makes reference to a “reinforced hose 300” or “hose 300” which, although not labeled in the figures, is understood to refer to the individual hose assembly that is shown in various states of assembly in FIGS. 3A-C.

FIG. 3A depicts individual components of the example reinforced hose 300: hose tubing 310, pressure sleeve 320, ferrule 330 and fitting 340. The components are not drawn to scale and certain components such as hose tubing 310 are shortened in length for ease of illustration—e.g., in some embodiments, hose tubing 310 is substantially longer than pressure sleeve 320. Hose tubing 310 is shown as being of a single layer construction, but various different hose and tubing construction methods can be employed without departing from the scope of the present disclosure, i.e., the present disclosure applies equally to instances in which hose tubing 310 forms a hose with a single layer construction as it does to instances in which hose tubing 310 forms the outermost layer of a multilayered hose. Hose tubing 310 can be selected from one or more of PVC, thermoplastic elastomer (TPE), thermoplastic polyurethane (TPU), nylon, PE, and synthetic and natural rubber. Pressure sleeve 320, as mentioned previously, comprises a heat shrink material which in some embodiments may be polyolefin or polyolefin based. In general, hose tubing 310 is not formed from a heat shrink material and maintains a substantially fixed inner and/or outer diameter during the application of a heat shrink process to any pressure sleeves installed on or about hose tubing 310.

As illustrated, pressure sleeve 320 has an inner diameter (ID) that is larger than the outer diameter (OD) of hose tubing 310; in other words, pressure sleeve 320 is sized such that it can encompass hose tubing 310 within its interior volume. This allows pressure sleeve 320 to fit over hose tubing 310 during the installation or manufacturing process. Moreover, the ID of pressure sleeve 320 can be sized such that it accounts for the OD of hose tubing 310 and any tolerance variation in this OD. For example, if hose tubing 310 is manufactured with an OD tolerance of ±0.05 inches, then the ID of pressure sleeve 320 in its non-shrunken state will be greater than the hose tubing OD+0.05 inches. In such a scenario where the pressure sleeve ID is only slightly larger than the hose tubing OD, pressure sleeve 320 will be tight-fitting when installed on hose tubing 310, even prior to the application of a heat shrink process. A lubricant can be utilized to reduce friction and resistance when installing a tight-fitting pressure sleeve onto a hose tubing.

Rather than using a tight-fitting pressure sleeve and lubricants, in some embodiments pressure sleeve 320 can be sized to have an ID that is appreciably larger than the OD of hose tubing 310 (e.g., at least 10-25% larger than the hose tubing OD). In this manner, pressure sleeve 320 can be easily installed onto hose tubing 310 without requiring the application of force to overcome the frictional resistance that arises with a tight-fitting pressure sleeve. Additionally, a “loose” pressure sleeve can be manually installed onto a hose tubing or integrated with an automated manufacturing process for such tubings (e.g., pressure sleeves could be installed onto sections of hose tubing as they come out of an extruder, with the pressure sleeves either pre-cut or cut in real-time during installation). Moreover, the use of a “loose” fitting pressure sleeve 320 can permit a single/uniform size strategy to be employed in manufacturing reinforced hoses having different ODs—a pressure sleeve that is sized to fit around the largest OD hose tubing can be installed and shrunk onto various other hose tubings having smaller ODs, given the wide range of shrink percentage exhibited by pressure sleeve 320, and advantageously reduces manufacturing costs and complexity by significantly reducing the total number of pressure sleeve sizes that need to be maintained in inventory.

As indicated by the directional arrows between the components depicted in FIG. 3A, pressure sleeve 320 is installed on top of and over the outer surface of hose tubing 310, ferrule 330 is installed over the outer surface of pressure sleeve 320 and fitting 340 is coupled into the open end of hose tubing 310 via ferrule 330. Note that these directional arrows are provided for simplicity of explanation of the relationship between the constituent components of reinforced hose 300 and are not limiting with respect to the order of installation steps in manufacturing reinforced hose 300. For example, rather than installing pressure sleeve 320 onto hose tubing 310 and then crimping ferrule 330 over both the installed pressure sleeve and the hose tubing, ferrule 330 could first be crimped to pressure sleeve 320 and the compound assembly then installed onto hose tubing 310.

In some embodiments, one or more pressure sleeves 320 can be placed about hose tubing 320 and then allowed to move or float freely along the longitudinal length of the hose tubing (e.g., because the ID of the pressure sleeves is sufficiently larger than the OD of the hose tubing). Such a configuration might be utilized when wishing to install the pressure sleeve(s) during the manufacture of hose tubing 310 (i.e., through an in-line step, e.g., as the hose tubing comes out of an extruder) without having to reduce the speed of hose tubing manufacture to match the process speed of aligning and heat shrinking a pressure sleeve 320 onto one or both ends of the hose tubing. In this manner, the pressure sleeve(s) 320 can be allowed to float along the length of hose tubing 310 until a separate alignment and heat shrinking process is performed at a subsequent time. This process can be performed manually or can be automated.

Pressure sleeve 320 is first brought into alignment with the open end of hose tubing 310 onto which it will be shrunk (if two pressure sleeves are installed, then each pressure sleeve is brought into alignment with its respective open end of hose tubing 310). For under the ferrule configurations such as the one depicted in FIGS. 3A-C and described with respect to reinforced hose 300, in some embodiments the open end of pressure sleeve 320 can be aligned with the open end of hose tubing 310, such that their end faces (i.e., cut along the radial direction, through the wall thickness of the pressure sleeve and hose tubing) are parallel or otherwise lie in substantially the same plane. For example, the open end of hose tubing 310 could be placed against a flat surface and pressure sleeve 320 then slid into correct alignment against the same flat surface. By positioning the open end of hose tubing 310 vertically, gravity can be used to move pressure sleeve 320 into alignment with hose tubing 310. In other embodiments, the end face of pressure sleeve 320 can extend beyond the end face of hose tubing 310, or the end face of hose tubing 310 can extend beyond the end face of pressure sleeve 320.

After pressure sleeve 320 and hose tubing 310 are brought into the desired alignment, a heat shrink process is applied to bring the inner surface of pressure sleeve 320 into tight contact with the outer surface of hose tubing 310, eliminating any gap between the pressure sleeve ID and hose tubing OD that was previously present, e.g., due to a “loose” fitting un-shrunken pressure sleeve. As mentioned previously, the pressure sleeve can be shrunk onto the hose tubing via a hot water bath or dip. Other heat application methods causing sufficient heat transfer into pressure sleeve 320 to trigger shrinking can also be utilized without departing from the scope of the present disclosure. In some embodiments, the heat shrinking operation can be applied or performed after the ferrule has been crimped in place on top of pressure sleeve 226 (although such a scenario might require that the pressure sleeve OD, in a non-shrunken state, closely match the ID of the ferrule—otherwise, as pressure sleeve 226 contracts from the heat shrinking operation, its outer surface will pull away from the crimped attachment with the ferrule).

Other heat shrinking methods such as the use of a heat gun or the application of radiant heat may also be employed. In some scenarios, these indirect heat transfer methods (“indirect” when considered in comparison to the “direct” method of submerging the pressure sleeve into a hot water or other fluid bath) can be utilized on the same manufacturing line as the hose tubing itself, although these methods risk overheating the actual hose tubing material itself and causing undesirable warping, weakening or other damage.

In the example of FIG. 3B, pressure sleeve 320 has been both installed onto hose tubing 310 and also moved into alignment with the open end of hose tubing 310 (although this alignment is not visible due to the installation of ferrule 330 onto the open ends of hose tubing 310 and pressure sleeve 320). In some embodiments, pressure sleeve 320 can be installed onto hose tubing 310 such that at the end of installation, pressure sleeve 320 is simultaneously brought into aligned with the open end of hose tubing 310. For example, with respect to FIGS. 3A and 3B, pressure sleeve 320 could be installed by being pushed to the left, over the outer surface of hose tubing 310. A relatively tight fit between the pressure sleeve ID (in its non-shrunken state) and the hose tubing OD can make it easier to achieve the desired alignment of the respective open ends at the end of installation, if such a procedure is utilized. Otherwise, particularly when a “loose” fit is employed between the pressure sleeve ID and the hose tubing OD, pressure sleeve 320 can be placed onto hose tubing 310 in the same leftward direction (still with respect to FIGS. 3A and 3B), but then allowed to continue traveling down the hose tubing 310 in the leftward direction, i.e. past the final alignment point in which pressure sleeve 320 will ultimately be installed via the heat shrink process. In this case, pressure sleeve 320 in a subsequent step would be moved back to the right until its open end is brought into desired alignment with the open end of hose tubing 310.

FIG. 3C illustrates the final assembled reinforced hose 300, after the inner surface of pressure sleeve 320 has been sealed to the outer surface of hose tubing 310 via the heat shrinking process. Additionally, fitting 340 has been installed, e.g., by expanding its tail or distal end in the interior volume of hose tubing 310, such that walls of hose tubing 310 and pressure sleeve 320 are compressed between fitting 340 and ferrule 330. Advantageously, no glue, adhesives, or mechanical connectors are utilized to seal pressure sleeve 320 to hose tubing 310. As illustrated, a distal portion of pressure sleeve 320 extends longitudinally beyond the terminal end of ferrule 330. The length of the pressure sleeve 320 can be made sufficiently long so as to ensure that the entirety of the transition zone centered at the transition point between the terminal end of ferrule 330 and the outer surface of hose tubing 310 is encapsulated and reinforced by pressure sleeve 320. In some embodiments, pressure sleeve 320 can extend past ferrule 330 by an amount equal to 2-4× the length of ferrule 330, although other length ratios may also be utilized.

The disclosure turns next to FIGS. 4A-C, which depict a reinforced hose 400 with a sleeve over ferrule configuration. The individual views of FIGS. 4A-C correspond to the views of FIGS. 3A-C, depicting the constituent components in FIG. 4A, a partially assembled state in FIG. 4B, and the final assembled state of the sleeve over ferrule reinforced hose in FIG. 4C. As was the case previously, the components are not drawn to scale and certain components such as hose tubing 410 are shortened in length for ease of illustration—i.e., in some embodiments hose tubing 410 is substantially longer than pressure sleeve 420. Moreover, one or more of the constituent components of reinforced hose 400 (hose tubing 410, pressure sleeve 420, ferrule 430 and fitting 440) can be identical or substantially similar to the corresponding components of reinforced hose 300 (e.g., hose tubing 310, pressure sleeve 320, ferrule 330 and fitting 340) as described above with respect to FIGS. 3A-C and the sleeve under ferrule configuration. Moreover, the foregoing description made with respect to the components of FIGS. 3A-C can be applied equally to one or more of the components of FIGS. 4A-C. In this sense, in some embodiments the same base components can be utilized to manufacture either reinforced hose 300 or reinforced hose 400—in other words, in some embodiments the same common components can be used to manufacture a sleeve under ferrule reinforced hose assembly or to manufacture a sleeve over ferrule reinforced hose assembly. In some embodiments, a first open end of a hose tubing might be configured with the pressure sleeve under the ferrule while a second open end of the hose tubing is configured with the pressure sleeve over the ferrule; alternatively, both the first and second open ends of the hose tubing can be configured with the same pressure sleeve-ferrule configuration. Still further, in some embodiments only one of the open ends of a hose tubing might be configured with either the sleeve over ferrule or sleeve under ferrule reinforcement mechanism, with the remaining open end left unreinforced.

As illustrated in FIG. 4A, in the pressure sleeve over the ferrule configuration, installation of pressure sleeve 420 and ferrule 430 can occur in opposite directions. For example, pressure sleeve 420 can be initially positioned on or about hose tubing 410 and allowed to move to a location distant (in the longitudinal direction) from the final alignment position into which pressure sleeve 420 will be installed and heat shrunk to encapsulate the outer surface of ferrule 430. With pressure sleeve 420 in this distant position on hose tubing 410, ferrule 430 and/or fitting 440 can then be installed onto the open end of hose tubing 410 (i.e., the right-hand open end as illustrated in FIGS. 4A-C).

With ferrule 430 and/or fitting 440 in place on the open end of hose tubing 410, pressure sleeve 420 can then be moved towards the same open end of hose tubing 410, up and over the outer surface of ferrule 430—into the aligned position for installation of pressure sleeve 420 via a heat shrink process. This step is shown in FIG. 4B, in which pressure sleeve 420 is brought up from a position closer to the center of the hose tubing and towards the installed ferrule 430 (i.e., moved from left to right). In instances in which the non-shrunken pressure sleeve 420 is tight-fitting about the outer surface of hose tubing 410, only the portion of pressure sleeve 420 that will ultimately encapsulate ferrule 430 needs to be stretched or forced over ferrule 430. By contrast, if pressure sleeve 420 were to be installed in the right to left direction, the entirety of pressure sleeve 420 must be stretched or forced over ferrule 430 in order to bring the pressure sleeve into the desired final alignment. Such a process can be more difficult to execute, requiring a greater and longer application of force while also posing risks of tearing or other undesired deformation/weakening in the non-shrunken pressure sleeve 430. Given the need for pressure sleeve 420 to fit over the outer surface of hose tubing 410 and the outer surface of ferrule 430—which will often have two different ODs (with ferrule 430 having the greater of the two)—the use of a “loose” fitting pressure sleeve while in the non-shrunken state can significantly simplify the manufacturing process for reinforced hoses in this sleeve over ferrule configuration.

In some embodiments, the installation of fitting 440 can provide an alignment mechanism that brings the open ends of pressure sleeve 420 and hose tubing 410 into the desired relative position for heat shrinking. As seen in FIGS. 4A-C, fitting 440 includes a flanged portion that extends radially beyond the maximum OD of ferrule 430. If the flanged portion of fitting 440 is wider than both ferrule 430 and the OD of the non-shrunken pressure sleeve 420, then it provides a flat surface against which pressure sleeve 420 can easily be brought into alignment with hose tubing 410. For example, the distal end of hose tubing 410 can be tilted vertically, such that gravity causes the free-floating pressure sleeve 420 to slide down the hose tubing and into proper alignment for heat shrinking, with the flanged portion of fitting 440 acting as a stop. With pressure sleeve 420 pulled into desired alignment by this or other means, the end portion of the reinforced hose assembly can then be positioned for the heat-shrinking process: if using a water bath, then the end portion can be dipped into the hot water bath, with care taken to ensure that the end portion is not placed into the hot water bath with such speed so as to cause the non-shrunken pressure sleeve 420 to shift out of the aligned position.

In both the sleeve under ferrule and sleeve over ferrule configurations (depicted in FIGS. 3A-C and FIGS. 4A-C respectively), a first interference joint is formed between the terminal portion of the shrunken pressure sleeve (i.e., away from the open end) and the proximal end of the ferrule crimped/installed on the hose tubing. This first interference joint brings the inner surface of the pressure sleeve into contact (compressive or otherwise) with the outer surface of the hose tubing and fully encapsulates the transition zone between the hose tubing and the ferrule, where unreinforced hoses are otherwise most prone to bursting and other failures.

In the sleeve under ferrule configuration of FIGS. 3A-C, a second interference joint is formed between the proximal end of the ferrule and the open end of the pressure sleeve, i.e., the compressive contact between the inner surface of the pressure sleeve and the outer surface of the hose tubing, located underneath the ferrule.

In the sleeve over ferrule configuration of FIGS. 4A-C, a second interference joint is also formed between the proximal end of the ferrule and the open end of the pressure sleeve, although here the contact zone/patch (compressive or otherwise) is between the inner surface of the pressure sleeve and the outer surface of the ferrule.

The duration of the hot water bath or heat-shrinking process (applied to either the sleeve over ferrule configuration or the sleeve under ferrule configuration) depends on factors that include the temperature of the process, heat transfer coefficients, thickness of the pressure sleeve, material composition of the pressure sleeve, etc. As mentioned previously, the temperature of the heat-shrinking process may, in some embodiments, be reduced to ensure that the hose tubing or other components besides the pressure sleeve do not experience undesired thermal contraction, melting, etc.

If the flanged portion of fitting 440 is not wider than the OD of the non-shrunken pressure sleeve 420, this flanged portion may still provide either a visual guide/reference point for manual alignment of the open ends of the pressure sleeve and the hose tubing, or can achieve the same functionality described above if the flanged portion of fitting 440 is wider than the ID of the non-shrunken pressure sleeve 420.

Once pressure sleeve 420 has been shrunken over the ferrule 440 in the desired alignment position, the shrunken pressure sleeve provides a compressive force in the radial direction that reinforces the hose tubing against shear forces that otherwise typically cause burst failures in unreinforced hoses at the transition point between the ferrule and the hose tubing wall.

What is claimed is:

1. A reinforced hose comprising:
a hollow hose tubing having first and second open ends;
a ferrule installed on the hose tubing about the first open end;
a pressure sleeve concentrically installed over an outer surface of the hose tubing, the pressure sleeve having first and second terminal ends with a hollow cylindrical tube formed therebetween, wherein:
an inner diameter of the pressure sleeve is larger than an outer diameter of the hose tubing;
the first terminal end of the pressure sleeve is longitudinally aligned with the first open end of the hose tubing; and
the second terminal end of the pressure sleeve extends longitudinally beyond a proximal end of the ferrule such that the longitudinal length of the pressure sleeve is greater than that of the ferrule, the proximal end of the ferrule being the portion thereof farthest from the first open end of the hose tubing; and
a first interference joint coupling the outer surface of the hose tubing to an inner surface of the pressure sleeve, the first interference joint comprising a contact patch located between the second terminal end of the pressure sleeve and the proximal end of the ferrule.

2. The reinforced hose of claim 1, wherein:
the inner surface of the pressure sleeve is in contact with the outer surface of the hose tubing along the full longitudinal length of the pressure sleeve; and
a portion of the pressure sleeve, located between the proximal end of the ferrule and the first open end of the hose tubing, is compressed between the outer surface of the hose tubing and an inner surface of the ferrule.

3. The reinforced hose of claim 2, wherein the ferrule is crimped in place on top of concentric layers formed by the pressure sleeve and the hose tubing, such that the portion of the pressure sleeve is compressed.

4. The reinforced hose of claim 2, further comprising a second interference joint coupling the outer surface of the hose tubing to the inner surface of the pressure sleeve, the second interference joint located between the proximal end of the ferrule and the first open end of the hose tubing.

5. The reinforced hose of claim 4, wherein one or more of the first interference joint and the second interference joint comprises a contact patch formed by heat shrinking the pressure sleeve onto the outer surface of the hose tubing.

6. The reinforced hose of claim 5, wherein the first and second interference joint comprise a single contact patch formed by a single heat shrinking operation.

7. The reinforced hose of claim 1, wherein:
the ferrule is crimped in place about the first open end of the hose tubing; and
the ferrule is encapsulated along its full longitudinal length by the pressure sleeve.

8. The reinforced hose of claim 7, wherein the outer surface of the hose tubing is in direct contact with an inner surface of the ferrule.

9. The reinforced hose of claim 8, wherein the pressure sleeve is installed on top of the crimped ferrule such that the outer surface of the ferrule is in contact with the inner surface of the pressure sleeve along a second contact patch.

10. The reinforced hose of claim 9, wherein the second contact patch between the outer surface of the ferrule and the inner surface of the pressure sleeve:
has a longitudinal length substantially equal to that of the ferrule; and
is located between the proximal end of the ferrule and the first open end of the hose tubing.

11. The reinforced hose of claim 10, wherein the second contact patch comprises a second interference joint.

12. The reinforced hose of claim 11, wherein the second interference joint comprises a heat shrink joint that radially compresses the ferrule and hose tubing along the second contact patch.

13. The reinforced hose of claim 12, wherein the first interference joint comprises a heat shrink joint along the first contact patch.

14. The reinforced hose of claim 13, wherein the first and second interference joints are formed in a single, continuous heat shrink operation.

15. The reinforced hose of claim 1, further comprising:
a second ferrule installed about the hose tubing at the second open end;
a second pressure sleeve concentrically installed over an outer surface of the hose tubing, the second pressure sleeve having first and second terminal ends with a hollow cylindrical tube formed therebetween, wherein:
an inner diameter of the second pressure sleeve is larger than an outer diameter of the hose tubing;
the first terminal end of the second pressure sleeve is longitudinally aligned with the second open end of the hose tubing; and
the second terminal end of the second pressure sleeve extends longitudinally beyond a proximal end of the second ferrule, such that the longitudinal length of the second pressure sleeve is greater than that of the second ferrule, the proximal end of the second ferrule being the portion thereof farthest from the second open end of the hose tubing; and
a third interference joint coupling the outer surface of the hose tubing to an inner surface of the second pressure sleeve, the third interference joint comprising a contact patch located between the second terminal end of the second pressure sleeve and the proximal end of the second ferrule.

16. The reinforced hose of claim 15, wherein the concentric arrangement of layers comprising the hose tubing at the second open end, the second ferrule, and the second pressure sleeve is installed in the same order as the concentric arrangement of layers comprising the hose tubing at the first open end, the first ferrule, and the first pressure sleeve.

17. The reinforced hose of claim 15, wherein the concentric arrangement of layers comprising the hose tubing at the second open end, the second ferrule, and the second pressure sleeve is installed in a different order as compared to the concentric arrangement of layers comprising the hose tubing at the first open end, the first ferrule, and the first pressure sleeve.

18. The reinforced hose of claim 1, wherein the hollow cylindrical tube formed between the first and second terminal ends of the pressure sleeve comprises a continuous smooth surface having a constant inner diameter.

19. The reinforced hose of claim 7, wherein the pressure sleeve has a constant inner diameter prior to installation over the crimped ferrule.

20. The reinforced hose of claim 1, wherein the hose tubing comprises one or more of polyvinyl chloride (PVC), thermoplastic elastomer (TPE), thermoplastic polyurethane (TPU), nylon, polyethylene, and synthetic and natural rubber; and the pressure sleeve comprises a polyolefin heat shrink material.
